(19) United States
(12) Patent Application Publication
(10) Pub. No.: US 2024/0162675 A1
(43) Pub. Date: May 16, 2024

(54) Dual-Band ASE Source Utilizing A Reflective Topology

(71) Applicant: II-VI Delaware, Inc., Wilmington, DE (US)

(72) Inventors: Ian Peter McClean, Brixham (GB); Martin R. Williams, Big Flats, NY (US)

(73) Assignee: II-VI Delaware, Inc., Wilmington, DE (US)

(21) Appl. No.: 17/987,015

(22) Filed: Nov. 15, 2022

(51) Int. Cl. H01S 3/094; H01S 3/067; H01S 3/16; H01S 3/23

(52) U.S. Cl. CPC H01S 3/094023; H01S 3/067; H01S 3/094042; H01S 3/1608; H01S 3/2391; H01S 2302/00

(57) ABSTRACT

An arrangement for generating amplified spontaneous emission (ASE) over the combination of the C-band and L-band wavelength ranges is proposed, based on a reflective topology that reduces the number of individual components (compared with separate C-band and L-band ASE sources) required to generate the broadband ASE output. A pair of ASE generators are used, where at least one of the generators is configured to include a reflective element at a termination of the included gain fiber. The inclusion of the reflective element allows for the generated emission to pass through the gain fiber twice (emulating the operation of a conventional dual-stage ASE source). A long wavelength portion of the ASE created by a first ASE generator may be used as a seed input by the remaining ASE generator of the pair to further increase the efficiency of extending the ASE along the L-band wavelength range.

### TECHNICAL FIELD

Disclosed herein is a fiber-based source used to provide amplified spontaneous emission (ASE) and, more particularly, to the use of a reflective topology that generates an output spectrum spanning both the C-band and L-band wavelength ranges.

### BACKGROUND OF THE DISCLOSURE

ASE sources are essentially fiber amplifiers that have no optical information signal input. The pump beam passes through a section of rare-earth doped fiber (typically, erbium-doped fiber (EDF)) where the interaction of the pump with the dopant first promotes spontaneous emission within the fiber, followed by amplification of the spontaneous emission. The generated ASE spans a wavelength range that is determined by pump parameters (e.g., wavelength, output power), and fiber characteristics (type of dopant, dopant concentration, fiber length). The created ASE is an optical type of “white noise” that exhibits a fixed output power over a broad wavelength range, and finds a variety of uses in different types of optical communication systems.

For example, there is a growing need for ASE sources in reconfigurable optical add/drop multiplexers (ROADMs), a component that is utilized at a node within an optical communication network to direct the flow of individual data signals (channels) through the node, as well as enter or exit the network at that node. ROADMs may be used to control the removal or addition of one or more channel wavelength slots at a node. The change in the number of channels carrying traffic results in a change in the total optical power that is exiting a particular node, which is problematic when attempting to use conventional amplifiers to impart a uniform gain profile across all of the channels.

One approach to reducing the power fluctuations associated with the add/drop process is to limit the number of individual channels that can be added or removed at a specific node at a given point in time. Alternatively, real-time channel power optimization can be performed, but is likely to result in slowing down the channel add/delete process.

A reasonable approach to minimizing power fluctuations, therefore, is to add ASE sources to an integrated circuit board supporting a ROADM component (also referred to as a “ROADM card”). The generated ASE can pass through as a replacement source (i.e., “fake” data) for idle channels so that the ROADM remains full, allowing for equalization to be performed and maintained regardless of the number of adds or drops going forward.

However, an ASE source design is similar to that of a rare earth-doped fiber amplifier (such as an erbium-doped fiber amplifier or EDFA) and comprises a significant number of discrete components including, for example, multiple sections of erbium-doped fiber, one or more pump lasers, and passive optical components in the form of isolators, couplers, filters, and the like. All of these discrete devices take up valuable space on the ROADM card, competing against the demand for more integration of optical functions and smaller real estate investment on the card.

Another concern relates to planned optical network upgrades to include additional channels at longer wavelengths beyond the C-band wavelength range (1525-1565 nm) currently in use. In particular, upgrades to the communications networks are proposed to include the L-band wavelength range (1565-1625 nm), essentially doubling the number of individual wavelength channels that may be used to support data being transmitted through the network. A ROADM that is configured to cover both the C-band and L-band wavelength ranges would therefore need an ASE source that covers the complete C+L wavelength range of 1525-1625 nm. The prior art approach is to include two separate ASE sources in a conventional ROADM card, one for each band. The duplication of ASE sources takes up considerable physical space on an ROADM card, requires a significant number of additional components, and thus adds to the cost and complexity of the add/drop multiplexer arrangement.

### SUMMARY OF THE DISCLOSURE

The principles described within the present disclosure relate to the provision of amplified spontaneous emission (ASE) as an optical source and, more particularly, to the use of a reflective topology that provides an output over both the C-band and L-band wavelength ranges in a relatively compact arrangement with a minimal number of individual components.

In particular, a dual-band ASE source is disclosed that utilizes one or more reflective elements in combination with sections of doped fiber to extend the optical path length of the ASE source beyond the physical length of the sections of doped fiber, the increase in optical path length allowing for ASE to be generated well into the L-band wavelength range. A reflective element is disposed at a far-end termination of a section of doped fiber and is used to re-direct initially-generated ASE to propagate through the doped fiber a second time (i.e., in the return direction), thus reducing by half the total amount of doped fiber required to generate ASE, as compared to prior art arrangements. The use of a reflective element to essentially double the optical path length of the doped fiber is particularly useful in extending ASE generation into the L-band wavelength region, which otherwise would require extremely long lengths of doped fiber and/or specialty fibers with unconventional dopant properties to extend the generated ASE into the L-band region.

Various embodiments take the form of a two-stage arrangement, with a section of doped fiber included in each stage and at least one reflective element. In certain embodiments, optical circulators may be utilized in place of multiple passive devices to efficiently direct the propagation of pump beams and the generated ASE through the doped fiber.

Advantageously, the longer wavelength portion of the ASE created along a first section of reflective doped fiber may be used as a seed input to a second, following section of reflective doped fiber. In this manner, the further generation of ASE within the L-band wavelength range is encouraged by the presence of this longer wavelength seed light. Again, the use of a section of doped fiber with a far-end reflective termination allows for a sufficient level of L-band ASE to be generated without requiring excessively long lengths of doped fiber (where the long lengths of fiber result in increasing the physical size of the ASE beyond that acceptable for inclusion on a ROADM card).

An example embodiment of the disclosed principles may take the form of a dual-band amplified spontaneous emission (ASE) source operational across a combination of the C-band wavelength range and the L-band wavelength range. In this example embodiment, the dual-band ASE source comprises a combination of a first ASE generator and a second ASE generator. The first ASE generator comprises at least one section of rare-earth doped fiber, and is responsive to the presence of an optical pump beam to generate ASE spanning a first wavelength region along the C+L wavelength range as a first generator output. The second ASE generator also comprises at least one section of rare-earth doped fiber and is responsive to the presence of an optical pump beam to generate ASE spanning a second wavelength region along the C+L wavelength range as a second generator output. The combination of the first and second generator outputs thus forming an output of the dual-band ASE spanning across the C+L band, wherein at least one of the first and second ASE generators is configured as a reflective module incorporating a reflective element at a termination of the at least one section of rare-earth doped fiber to create an optical path length greater than a physical length of the at least one section of rare-earth doped fiber.

Other and further embodiments and aspects of this disclosure will become apparent during the course of the following discussion and by reference to the accompanying drawings.

### BRIEF DESCRIPTION OF THE DRAWINGS

Referring now to the drawings, where like numerals represent like components in several views:

FIG. 1 is a prior art simplified block diagram of a node in an optical network, showing the use of an ASE source with a ROADM;

FIG. 2 illustrates a typical prior art C-band ASE source, as may be used in the prior art node of FIG. 1;

FIG. 3 is a high level diagram of an example dual-band ASE source formed in accordance with the disclosed principles, in this case configured to use a parallel set of reflective doped fibers, with an optical combiner used to direct the ASE generated by the set of parallel doped fibers along an output path as C+L band ASE;

FIG. 4 shows an example embodiment of the dual-band ASE source of FIG. 3;

FIG. 5 is a high level diagram of an alternative dual-band ASE source also formed in accordance with the disclosed principles, in this case using a longer wavelength portion of the ASE created along the first doped fiber as a seed input for the second doped fiber;

FIG. 6 shows an example embodiment of the arrangement of FIG. 5, using a two-stage ASE generator in combination with a reflective ASE generator; and

FIG. 7 illustrates an alternative embodiment of the arrangement of FIG. 5, in this case using reflective configurations in both the first and second ASE generators.

### DETAILED DESCRIPTION

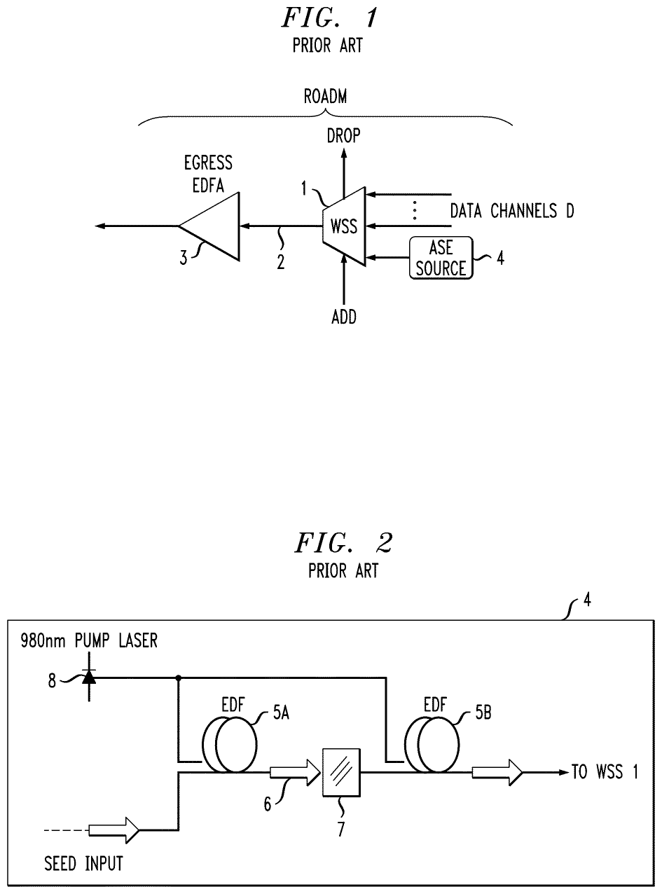

The prior art diagrams of FIGS. 1 and 2 illustrate the use of an ASE source within a ROADM arrangement at a communication node within an optical network. In particular, FIG. 1 shows basic elements found at an egress node of a network, where a number of different data channels D (each operating at a different wavelength) are passed through a wavelength-selective switch (VVSS) 1 and multiplexed onto a single output path 2. The collection of multiplexed data channels is then amplified within an egress EDFA 3 before exiting the node and continuing through the network. WSS 1 is responsive to external control signals used to modify the specific number of data channels that are leaving the egress node. For example, one or more data channels may be dropped (i.e., routed to a local termination at that node) or added (i.e., a new data stream now joining the network at that node). As mentioned above, the add/drop is typically a random event, if no limits are imposed on how many changes in the channel assignment are permitted. An ASE source 4 is provided, therefore, as an additional input to WSS 1, where ASE source 4 creates a type of white noise beam (i.e., fake data) that is passed into any empty channels of WSS 1. Therefore, egress EDFA 3 will always see the same optical input, regardless of the number of true data channels in use, and may be configured accordingly.

FIG. 2 is a diagram of a typical prior art ASE source 4 as used in the arrangement of FIG. 1. As mentioned above, an ASE source is quite similar to a doped fiber amplifier, except that no designated optical data signal is applied as an input. The included doped fiber is thus responsive only to an applied pump beam, where the launched pump beam generates spontaneous emission, which is thereafter amplified by stimulated emission. The pump-supplied spontaneous emission contributes to the amplification until the amplification reaches a level that makes the addition of “new” spontaneous emission insignificant. In the specific embodiment of FIG. 2, prior art ASE source 4 includes a pair of erbium-doped fiber (EDF) sections 5A, 5B, separated by the combination of an isolator 6 and a gain-flattening filter (GFF) 7. A standard pump input 8 (here, a laser diode operating at 980 nm) is applied as an input to each EDF 5A and 5B, creating the initial spontaneous emission that ultimately forms the amplified output, i.e., the generated ASE. GFF 7 functions in a known manner to minimize the variations in generated optical power at various wavelengths within the designated band (such as the C-band). The gain-flattened ASE then passes through second EDF 5B which imparts a sufficient amount of gain to the input spectrum that the output may be used as the white noise channel “placeholder” into WSS 1 (see FIG. 1).

As mentioned above, while an ASE source as shown in FIG. 2 functions well as a channel placeholder in this circumstance, the advance to configuring ROADMs to operate across both the C-band and L-band wavelength ranges results in the need to include a pair of ASE sources; i.e., individual ASE sources for each wavelength band. The principles as described in detail below are a result of the motivation to reduce the number and size of optical components needed to provide a suitable ASE source for operation across the complete C+L band (i.e., 1525-1625 nm).

More particularly, a C+L band ASE source (referred to at times hereafter as a “dual-band” ASE source) is proposed that utilizes a reflective far-end termination along one or more sections of doped fiber (typically, erbium-doped fiber; however, other rare-earth dopants may be used). The inclusion of the reflective far-end terminations significantly reduces the total length of the doped fibers required to provide a useful level of output power across the entire C+L band. Optical circulators may be used to efficiently direct the various light waves (pumps, amplified beams) through the ASE source to replace a larger number of individual passive components (e.g., couplers, isolators, etc.) that would be required in an arrangement similar to the prior art.

In some embodiments, a longer wavelength portion of the ASE created within a first section of doped fiber may be used as a seed input to a second section of doped fiber (the second section preferably including a reflective far-end termination), providing a relatively small-sized and efficient configuration for providing ASE across the desired C+L wavelength range.

FIG. 3 is a simplified diagram of an example dual-band ASE source 10 formed in accordance with these principles. In this particular embodiment, dual-band ASE source 10 comprises a parallel arrangement of a first ASE generation path and a second ASE generation path, with a reflective element disposed at the termination of each path. A first ASE generator 12, including a first length L1 of a doped fiber 13, is shown as receiving a pump beam P 1 from an associated pump source 16. Pump beam P 1 operates at a wavelength known to generate gain within doped fiber 13 via stimulated emission. This pump beam P₁ also generates optical power within the wavelength band through spontaneous emission that is then amplified through stimulated emission and becomes “amplified spontaneous emission”. For example, pump source 16 may comprise a semiconductor laser diode operating at 980 nm when the doped fiber comprises an erbium-doped fiber. The pump beam initiates spontaneous emission in a known manner that leads to amplification of the created emission as it propagates through first ASE generator 12. Consequently, a spontaneous emission effect will continue to contribute energy to the optical energy created within doped fiber 13 until the existing spontaneous emission is amplified to a level that renders the continuing generation of spontaneous emission insignificant.

A reflective element 14 is disposed at an end termination of doped fiber section 13 and functions to re-direct the initially-generated ASE to pass a second time through the doped fiber (i.e., in the reverse direction). The presence of the continuously supplied pump light imparts additional optical energy to the initially amplified light, thus emulating a prior art dual-loop configuration. As a result of using a reflective configuration, the length L1 of doped fiber 13 may be about half of that used in prior art arrangements and still generate ASE across the same wavelength range. In some arrangements, pump source 16 may be integrated with reflective element 14, with pump beam P₁ coupled into first ASE generator 12 as a counter-propagating pump (with respect to a defined optical axis of the included doped fiber section 13). FIG. 3 depicts this integrated arrangement. The ASE output from first ASE generator 12 is shown as directed into an optical combiner 18 (for example, a thin film optical filter) and thereafter coupled into an output path 20 of dual-band ASE source 10.

A second ASE generator 22 is included in the arrangement of dual-band ASE source 10 of FIG. 3, and is shown as including a second section of doped fiber 23 having a length L2 that is greater than L1. As known in the art, extending the optical path length over which ASE is generated allows for the wavelength range of the ASE to be extended; here, the intent is to provide an ASE output that extends across both the C-band and L-band wavelength ranges (C+L band; the output defined as C+L ASE). Second ASE generator is shown as responsive to a separate pump source 26. A reflective element 24 is disposed at an end termination of a doped fiber 23 and re-directs the initially-generated ASE through the doped fiber a second time, similar in function to the operation of first ASE generator 12. Also similar to the arrangement of first ASE generator 12, pump source 26 may be integrated with reflective element 24 and applied as a counter-propagating pump input to doped fiber 23. The ability to integrate the pump laser diode and reflective element further improves the compactness of the inventive C+L band ASE source. The longer wavelength ASE output (typically, this output extending at least across the L-band wavelength range) from second ASE generator 22 is shown in FIG. 3 as also passing through optical combiner 18 to be directed along output path 20.

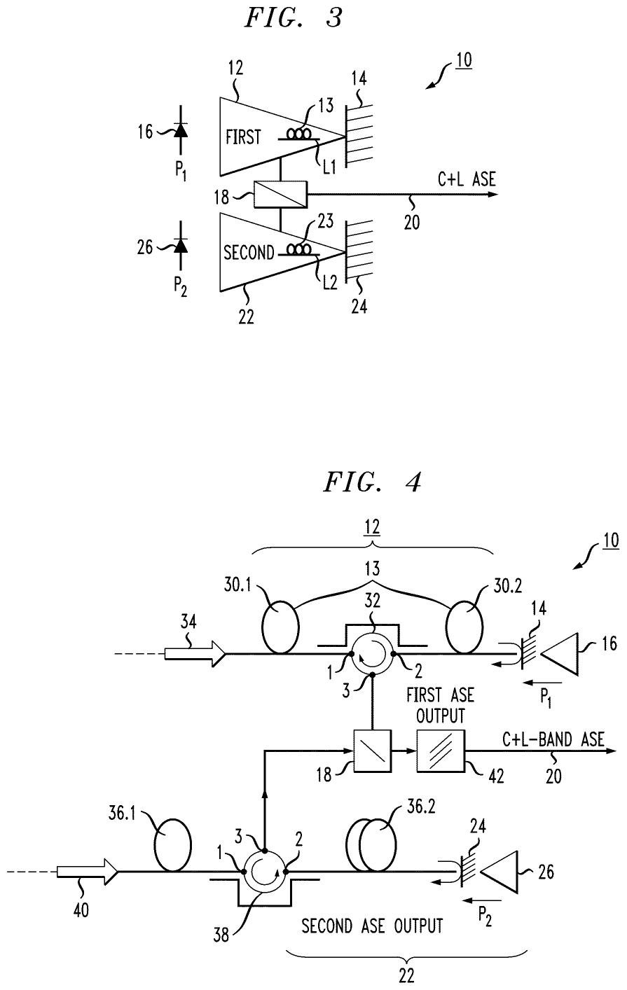

An example embodiment of C+L band ASE source 10 is shown in FIG. 4. First ASE generator 12 is shown as utilizing two separate sections of doped fiber, shown as 30.1 and 30.2, as doped fiber 13 of FIG. 3. In the embodiment as shown in FIG. 4, an optical circulator 32 is disposed between the two doped fiber sections 30.1 and 30.2. Reflective element 14 is shown as disposed at a far-end termination of second doped fiber section 30.2, and in this particular arrangement of first ASE generator 12, pump source 16 is integrated with reflective element 14, directing pump beam P₁ through reflective element 14 and into the far-end termination of second doped fiber section 30.2. An optical isolator 34 is shown as disposed at the input of first doped fiber section 30.1 and used to reduce the amount of backward-propagating ASE (and thus prevent any self-lasing from occurring).

The initial spontaneous emission created along first doped fiber section 30.1 is directed into an input port of optical circulator 32 (shown as input port 1 in FIG. 4), and thereafter propagates through optical circulator 32 and exits at bi-directional port 2. Second doped fiber section 30.2 is coupled to port 2 and, therefore, the initial light generated within first doped fiber section 30.1 is coupled into second doped fiber section 30.2. Pump beam P₁ is also applied as an input to second doped fiber section 30.2, where the pump beam is selected to operate at a wavelength that interacts with the particular rare-earth dopant within second doped fiber section 30.2 (for example, a pump wavelength of 980 nm is known to provide amplification in the presence of erbium dopant). In the arrangement shown where pump source 16 is integrated with reflective element 14, pump beam P₁ travels in a counter-propagating direction along second fiber section 30.2 with respect to initial spontaneous emission injected from bi-directional port 2 of optical circulator 32.

Since there is no input optical data signal, the combination of the spontaneous emission and pump beam P₁ within second fiber section 30.2 functions to result in triggering spontaneous broadband emission, which is thereafter amplified. As the initially-generated ASE reaches reflective element 14, it is re-directed to propagate another time along second doped fiber section 30.2, where the continuing presence of pump beam P₁ with this initially-created ASE increases the optical power of the ASE. The generated ASE is thereafter coupled into bi-directional port 2 of optical circulator 32, which then directs this optical beam out of a third port of optical circulator 32 (shown as output port 3 in FIG. 4).

By virtue of including reflective element 14 along the optical path of first ASE generator 12, the physical length of second doped fiber section 30.2 can be reduced with respect to that required in the prior art, since ASE is created during each pass of the generated light through the fiber. The use of optical circulator 32 eliminates the need for individual couplers and isolators to be disposed along the optical path of first ASE generator 12, reducing the size and component count of the disclosed ASE source with respect to prior art arrangements.

Second ASE generator 22 is shown in FIG. 4 as having components similar to those shown in first ASE generator 12, and arranged in a like manner. In particular, second ASE generator 22 is shown as utilizing suitable lengths of a first doped fiber section 36.1 and a second doped fiber section 36.2 to provide doped fiber section 23 of a length L2 (as depicted in FIG. 3). A three-port optical circulator 38 is included within second ASE generator 22 and is disposed between doped fiber sections 36.1 and 36.2. Similar to the configuration of first ASE generator 12, pump source 26 of second ASE generator 22 is integrated with reflective element 24, providing pump beam P₂ as a counter-propagating pump input along second doped fiber section 36.2. An optical isolator 40 is included along the input to first doped fiber section 36.1 to prevent reflections from re-entering a seed source.

Initial spontaneous emission (and amplification) exits from first doped fiber section 36.1 and is directed into a first (input) port 1 of optical circulator 38. This light then exits bi-directional port 2 of optical circulator 38 and is coupled into second doped fiber section 36.2. Pump light P₂ enters second doped fiber section 36.2 through reflective element 24, and further reacts with the initially-generated ASE to extend the output bandwidth of the ASE, in this case further into the L-band wavelength range. The presence of reflective element 24 causes the generated ASE to pass again through second doped fiber section 36.2, promoting additional interaction between the pump beam and the initial ASE to further extend the wavelength range of the generated ASE, emulating the use of a dual-loop configuration. The use of a reflective element within second ASE generator 22 is particularly significant, since the provision of ASE within this longer wavelength region would otherwise require relatively long lengths of doped fiber (as well as high-power pump sources). The generated, longer-wavelength ASE subsequently re-enters optical circulator 38 at bi-directional port 2, where it propagates along and thereafter exits the device at its output port 3 (which is also the exit port of second ASE generator 22).

As shown in FIGS. 3 and 4, the output from second ASE generator 22 is also applied as an input to optical combiner 18. Optical combiner 18 thereafter directs both the shorter wavelength ASE created in first ASE generator 12 and the longer wavelength ASE created in second ASE generator 22 into output path 20, forming the C+L band ASE output of dual-band ASE source 10. In the particular embodiment of FIG. 4, a gain flattening filter (GFF) 42 is disposed along output signal path 20. Particularly in light of providing an output ASE that spans this extended bandwidth, GFF 42 may be configured to minimize the nonuniformity in ASE output power across the complete C+L-band of 1525-1625 nm. Advantageously, only a single GFF is required in an arrangement formed in accordance with the principles of the present disclosure, as opposed to the prior art use of separate GFFs with the separate C-band and L-band ASE sources.

Also in comparison to prior art configurations that utilize separate C-band and L-band ASE sources, the reflective arrangement as discussed above in FIGS. 3 and 4 requires a fewer number of discrete components and shorter lengths of doped fiber. The use of a pair of optical circulators, instead of sets of isolators and couplers, further decreases the size and complexity of the final C+L band ASE source 10.

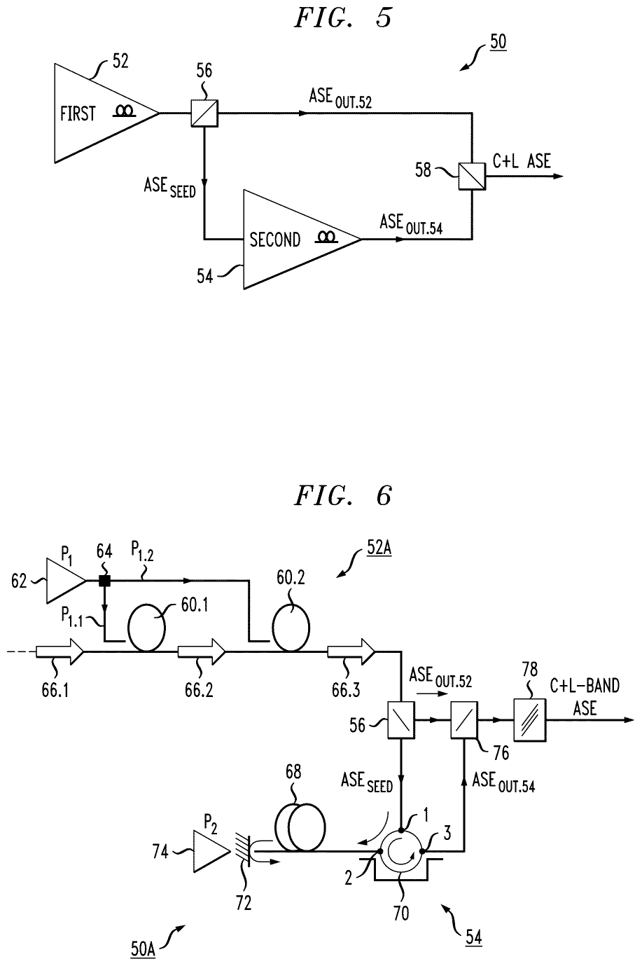

FIG. 5 is a simplified diagram of an alternative dual-band ASE source 50 formed in accordance with the principles of this disclosure. Here, a portion of the ASE created within the first ASE generator is used as a seed input for the second ASE generator. In particular, a longer wavelength portion of the initially-generated ASE is utilized as an effective and efficient seed source for ensuring that the output ASE extends across the full C+L wavelength region. In this particular embodiment, a dual-band ASE source 50 is shown as comprising a first ASE generator 52 and a second, reflective ASE generator 54, where a longer wavelength portion of the initially generated ASE is provided as an input to second ASE generator 54 by an included dichroic filter 56. In particular, dichroic filter 56 is configured to direct the shorter wavelength portion of the generated ASE (e.g., 1525-155× nm) toward the output of source 50, and the remaining longer wavelength portion into second ASE generator 54. The specific demarcation between the “shorter wavelength portion” and the “longer wavelength portion” is considered to be a design consideration and may depend on the specific application.

FIG. 6 illustrates an example embodiment of the configuration of FIG. 5. In this embodiment, denoted as dual-band ASE source 50A, a first ASE generator 52A utilizes a co-pumped amplifying arrangement including a pair of concatenated sections of doped fiber, denoted as first doped fiber section 60.1 and second doped fiber section 60.2. In this specific embodiment, a single pump source 62 is used to supply pump light P₁ to both fiber sections, with an included pump power splitter 64 directing a first pump beam P^{1.1} into a near-end termination of first doped fiber section 60.1 and a second pump beam P_{1.2} into a near-end termination of second doped fiber section 60.2. A set of optical isolators 66.1, 66.2, and 66.3 is disposed as shown to prevent reflections from passing in the counter-propagating direction through first ASE generator 52A. In this particular embodiment, no reflective elements are disposed along signal path defined by the concatenated arrangement of doped fiber sections 60.1 and 60.2.

The ASE output from second doped fiber section 60.2 (defined as the output of first ASE generator 52A) is thereafter applied as an input to dichroic filter 56. As discussed above in association with FIG. 5, a higher-wavelength portion of the ASE created within first ASE generator 52A (denoted here as ASE_{seed}) is utilized as a seed input to second, reflective ASE generator 54, with the remaining, lower-wavelength portion of the ASE output from first ASE generator 52A (denoted here as ASE_{out.52}) forming a portion of the dual-band ASE output.

Second, reflective ASE generator 54 is shown in FIG. 6 as comprising a single section of doped fiber 68, where the input ASE see d from first ASE generator 52A is directed into doped fiber 68 by an included three-port optical circulator 70. Specifically, ASE_{seed} is coupled into optical circulator 70 at an input port 1, and thereafter exits at a second, bi-directional port 2, which is coupled to doped fiber 68. A reflective element 72 is disposed at the opposing end termination of doped fiber 68, where the passage of the spontaneous emission (and amplification) in both directions along doped fiber 68 thus emulates “dual stage” amplification, such as that provided by first ASE generator 52A. Advantageously, the use of the higher-wavelength portion of the initially-generated ASE (i.e., ASE_{seed}) to seed the ASE generation within doped fiber 68 allows for efficient creation of ASE well into the L-band wavelength region, preferably up to the wavelength of 1625 nm. As shown, the ASE created within doped fiber 68 (denoted ASE_{out.54}) enters circulator 70 at bi-directional port 2 and propagates through to exit at a third, output port 3 of optical circulator 70.

An optical combiner 76 is shown as receiving as separate inputs the lower-wavelength ASE output from first ASE generator 52A (i.e., ASE_{out.52}) via dichoric filter 56 and the ASE output from second ASE generator 54 (i.e., ASE_{out.54}) via circulator 70, combining them to create the C+L ASE output that extends across the wavelength range from 1525-1625 nm. As with the first embodiment described above in association with FIGS. 3 and 4, a GFF 78 may be positioned along the output path of dual-band ASE source 50A to reduce nonlinearities in the gain profile across the complete C+L wavelength span.

Also shown in FIG. 6 is a separate pump source 74 that may be incorporated with reflective element 72 of second ASE generator 54. The inclusion of pump source 74 is considered as optional, since the seed input from first ASE generator 52A, as discussed above, is used to encourage the spontaneous emission within doped fiber section 68. The use of a pump beam P₂ is thought to improve the conversion efficiency within the longer wavelength range, as well as perhaps required a smaller extent of the long wavelength portion of the ASE generated within first ASE generator 52A (thus increasing the bandwidth of ASE_{out.52})

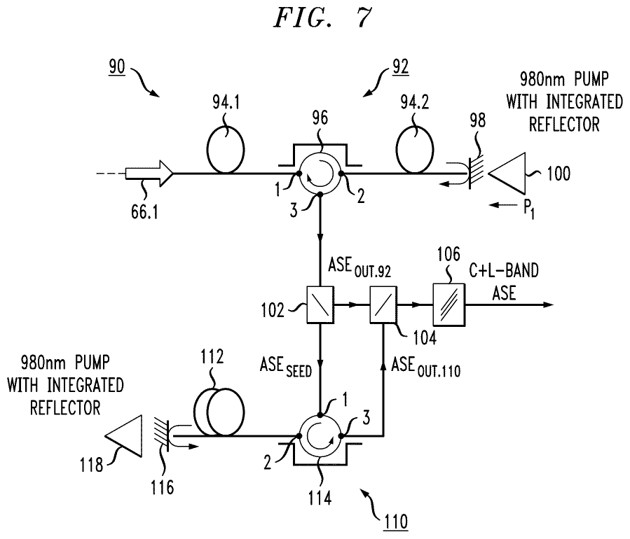

An alternative embodiment of a dual-band ASE source formed in accordance with the present disclosure is shown in FIG. 7. In this particular embodiment, denoted as C+L band ASE 90, a first ASE generator 92 is formed as a reflective configuration, similar to that utilized in dual-band ASE source 10 as shown in FIG. 4. That is, first ASE generator 92 comprises a pair of doped fiber sections 94.1 and 94.2 that are coupled together via an included optical circulator 96. A reflective element 98 is disposed at the far-end termination of second doped fiber section 94.2, with a counter-propagating pump beam P₁ from a pump source 100 passing through reflective element 98 and coupled into second doped fiber section 94.2.

The initial amount of spontaneous emission generated within first doped fiber section 94.1 is shown as passing through optical circulator 96 and entering second doped fiber section 94.2 (via the bi-directional port (port 2) of circulator 96). The interaction of this spontaneous emission with the pump light creates an initial level of amplification, where as the forward-propagating emission reaches reflective element 98 and passes another time through second doped fiber section 94.2, the wavelength range of the spontaneous emission, as well as its amplification, increases. This created ASE is then coupled into bi-directional port 2 of optical circulator 96, and thereafter exits at output port 3 of circulator 96.

Similar to dual-band ASE source 50 discussed above in association with FIG. 6, a dichroic filter 102 is included within ASE source 90 at the output of first ASE generator 92 (in particular, coupled to output port 3 of circulator 96) and used to direct a higher-wavelength portion of the created ASE created as a seed input to a second ASE generator 110 (this seed input denoted as ASE_{seed} in FIG. 7). The lower-wavelength portion of the generated ASE (referred to as ASE_{out.92} is directed by dichroic filter 102 along an output signal path of dual-band ASE source 90.

Second ASE generator 110 of dual-band ASE source 90 is configured as a reflective arrangement, including a section of doped fiber 112 disposed between an optical circulator 114 and a reflective element 116. The ASE see d output from dichroic filter 102 is shown as directed into input port 1 of optical circulator 114, which thereafter directs this seed input to exit at bidirectional port 2 and be coupled into doped fiber 112. As with the other arrangements described above, the initially-created ASE is redirected by reflective element 116 to pass a second time through doped fiber 112 and re-enter circulator 114 at bidirectional port 2. By virtue of the use of the higher-wavelength seed (and perhaps also a separate pump 118 also coupled into doped fiber 112), the ASE created within second ASE generator 110 (denoted as ASE_{out.110}) extends into the longer wavelength portion of the L-band wavelength range.

This higher-wavelength ASE output ASE_{out.110} from second ASE generator 110 is shown in FIG. 7 as applied as an input to an optical combiner 104, where the lower-wavelength portion of ASE created by first ASE generator 92 (ASE_{out 0.92}) is also applied as an input to combiner 104. In accordance with the disclosed principles, therefore, the output from optical 104 is the desired C+L band ASE. A GFF 106 may be included along the output path, if desired, to reduce nonlinearities in the gain profile across the C+L band of the output ASE.

Although the disclosed principles have been illustrated and described herein with reference to certain preferred embodiments and specific examples thereof, it will be readily apparent to those of ordinary skill in the art that other embodiments and examples may perform similar functions and/or achieve like results. All such equivalent embodiments and examples are within the spirit and scope of this disclosure, are contemplated thereby, and are intended to be covered by the claims appended hereto.

What is claimed is:

1. A dual-band amplified spontaneous emission (ASE) source operational across a combination of the C-band wavelength range and the L-band wavelength range, the dual-band ASE source comprising
a first ASE generator comprising at least one section of rare-earth doped fiber, responsive to the presence of an optical pump beam to generate ASE spanning a first wavelength region along the C+L wavelength range as a first generator output; and
a second ASE generator comprising at least one section of rare-earth doped fiber and responsive to the presence of an optical pump beam to generate ASE spanning a second wavelength region along the C+L wavelength range as a second generator output, the combination of the first and second generator outputs forming an output of the dual-band ASE spanning across the C+L band, wherein at least one of the first and second ASE generators is configured as a reflective module incorporating a reflective element at a termination of the at least one section of rare-earth doped fiber to create an optical path length greater than a physical length of the at least one section of rare-earth doped fiber.

2. The dual-band ASE source as defined in claim 1, further comprising
an optical combiner responsive to the outputs of the first and second ASE generators, coupling both first and second generator outputs onto a common output path as the C+L band ASE output of the dual-band ASE source.

3. The dual-band ASE source as defined in claim 2, wherein the dual-band ASE source further comprises a gain flattening filter disposed along the common output path.

4. The dual-band ASE source as defined in claim 1, wherein a longer-wavelength portion of the first generator output is provided as a seed input to the second ASE generator.

5. The dual-band ASE source as defined in claim 4, wherein the dual-band ASE source further comprises an optical filter disposed at the output of the first ASE generator, the optical filter configured to direct the longer-wavelength portion of the first generator output into the second ASE generator to provide the seed input, the optical filter directing the remaining, shorter-wavelength portion of the first generator output into the common output path.

6. The dual-band ASE source as defined in claim 5, wherein the optical filter comprises a tunable filter for adjusting a wavelength range within the longer-wavelength portion provided as a seed input to the second ASE generator.

7. The dual-band ASE source as defined in claim 5, wherein the optical filter comprises a dichroic filter.

8. The dual-band ASE source as defined in claim 1, wherein a longer wavelength edge of the first generator output overlaps a shorter wavelength edge of the second generator output.

9. The dual-band ASE source as defined in claim 1, further comprising a counter-propagating pump source integrated with the reflective element.

10. The dual-band ASE source as defined in claim 1, wherein the second ASE generator comprises a reflective module.

11. The dual-band ASE source as defined in claim 1, wherein the first ASE generator comprises a reflective module.

12. The dual-band ASE source as defined in claim 1, wherein the first ASE generator comprises a first reflective module and the second ASE generator comprises a second reflective module.

13. The dual-band ASE source as defined in claim 1, wherein the reflective module further comprises a three-port optical circulator including an input port, a bi-directional signal port, and an output port, a first section of rare-earth doped fiber coupled to the input port such that any spontaneous emission generated therein propagates through the optical circulator and exits at the bidirectional port, a second section of rare-earth doped fiber coupled at a first end termination to the bi-directional port and at a second end termination to the reflective element, wherein the ASE generated within the second section of rare-earth doped fiber is directed into the bi-directional port of the optical circulator and propagates therethrough to exit the reflective module at the output port of the reflective module.

14. The dual-band ASE source as defined in claim 1, wherein each section of rare-earth doped fiber comprises a section of erbium-doped fiber and each pump beam operates at a wavelength of about 980 nm.
